(19) United States
(12) Patent Application Publication
(10) Pub. No.: US 2011/0030254 A1
(43) Pub. Date: Feb. 10, 2011

(54) AIR PILLOW MARKETING DEVICE

(76) Inventors: Chung-Hou Tony Hsiao, Irvine, CA (US); Kuo-Yow Yen, Irvine, CA (US)

Correspondence Address: LAW OFFICES OF CLEMENT CHENG, 17220 NEWHOPE STREET #127, FOUNTAIN VALLEY, CA, 92708, US

(21) Appl. No.: 12/844,114

(22) Filed: Jul. 27, 2010

Related U.S. Application Data
(60) Provisional application No. 61/273,685, filed on Aug. 7, 2009.

(51) Int. Cl. G09F 19/00

(52) U.S. Cl. 40/603

(57) ABSTRACT

A method of marketing includes the steps of: fabricating an air pillow having a top layer, one or more intermediate layers and a bottom layer; heat laminating the top layer to the one or more intermediate layers and heat laminating the bottom layer to the one or more intermediate layers; printing advertising on a first top sheet of the air pillow; forming a one-way valve on the air pillow, and distributing the air pillow as package packing material. The one-way valve is formed by and between the top layer and the bottom layer. Preferably, a plurality of micro air pockets are formed in the intermediate sheet. Optionally, the air pillow can be formed as a plurality of air cells, and a column of logos can be printed on each of the plurality of air cells.

This application is a non-provisional claiming domestic priority from provisional application 61/273,685 filed Aug. 7, 2009, by first named inventor Chung-Hou Tony Hsiao the disclosure of which is incorporated herein by reference.

### FIELD OF THE INVENTION

This invention is in the field of marketing and promotional devices.

### DISCUSSION OF RELATED ART

The air pillow is a useful alternative to foam peanuts and has been used for packaging in shipping cardboard boxes with products. Traditionally, inflated air pillow provides a cushion for products shipped by courier.

### SUMMARY OF THE INVENTION

A method of marketing includes the steps of fabricating an air pillow having a top layer, one or more intermediate layers and a bottom layer; heat laminating the top layer to the one or more intermediate layers and heat laminating the bottom layer to the one or more intermediate layers; printing advertising on a first top sheet of the air pillow; forming a one-way valve on the air pillow, and distributing the air pillow as package packing material. The one-way valve is formed by and between the top layer and the bottom layer. Preferably, a plurality of micro air pockets are formed in the intermediate sheet. Optionally, the air pillow can be formed as a plurality of air cells, and a column of logos can be printed on each of the plurality of air cells.

### BRIEF DESCRIPTION OF THE DRAWINGS

FIG. 1 is a diagram of the present invention air pillow having a single cell.

FIG. 2 is a diagram of the present invention air pillow having multiple cells.

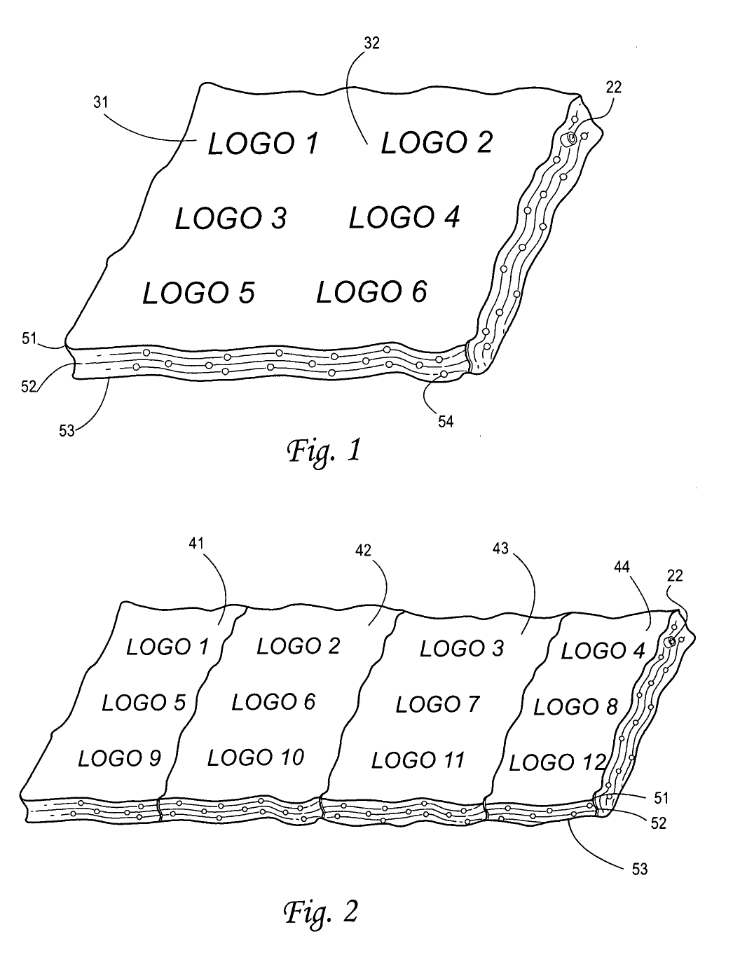

The following call out list of elements may be a useful reference for referencing elements of the drawings.
22 One-Way Valve
31 Firsts Logo
32 Second Logo
41 First Air Cell
42 Second Air Cell
43 Third Air Cell
44 Fourth Air Cell
51 Top Layer
52 Intermediate Layers
53 Lower Layer
54 Micro Air Pockets

### DETAILED DISCUSSION OF THE PREFERRED EMBODIMENTS

The present invention is a method of advertising on packing material used for packing products. The packing material is an air pillow that may have one or more cells. The packing material is distributed as air pillow as package packing material in a flat configuration for inflating by the customer. A hand pump can be included with the air pillow packaging material.

The preferred embodiment is an air pillow construction where multiple air chambers are formed by lamination of plastic sheets together in a continuous roll. A roll of plastic can be rolled in a first direction along the length of the roll. In one possible construction of the packing material, an inflatable structure can be made of three layers of sheets of plastic. The first sheet may have printing on it, such as warnings, product description, patent markings and product use instructions.

The first sheet can be the top sheet 51 and the top sheet can be laminated to one or more intermediate sheets 52. The second sheet can be the intermediate sheet 52 and the intermediate sheet is preferably heat laminated to the top sheet along lamination lines so that the intermediate sheet forms a plurality of circuitous channels or micro air pockets 54 between the intermediate sheet and the top sheet. Lamination lines between the top sheet and the intermediate sheet may form a plurality of circuitous channels. The air valve 22 is formed between the top layer and bottom layer when the top layer is laminating against the bottom layer. The air valve 22 can be self closing when made as a circuitous channel which self closes after the air pressure inside the air pillow presses against the walls of the top sheet, bottom sheet and intermediate sheets. The self closing air valve is a one way air valve.

A number of logos such as a first logo 31 or a second logo 32 can be imprinted on the top layer 51. The logos can be arranged in an array and revenue collected for printing of logos. Revenue can be in the form of royalties, rents or otherwise. The logos can be printed in columns so that when inflated, the individual cells form columns. For example, the first air cell 41 and the second air cell 42 and the third air cell 43 and the fourth air cell can be defined between the vertical lamination seams which define rectangular air cells.

The air pillow construction is preferably constructed with biodegradable material.

1. A method of marketing comprising the steps of:
a. fabricating an air pillow having a top layer, one or more intermediate layers and a bottom layer;
b. heat laminating the top layer to the one or more intermediate layers and heat laminating the bottom layer to the one or more intermediate layers;
c. printing advertising on a first top sheet of the air pillow;
d. forming a one-way valve on the air pillow, wherein the one-way valve is formed by the top layer and the bottom layer; and
e. distributing the air pillow as package packing material in a flat configuration for inflating by the customer.

2. The method of marketing of claim 1, further comprising the step of: forming a plurality of micro air pockets in the intermediate sheet.

3. The method of marketing of claim 2, further comprising the step of: forming a plurality of air cells, wherein a column of logos are printed on each of the plurality of air cells.

4. The method of marketing of claim 1, further comprising the step of: forming a plurality of air cells, wherein a column of logos are printed on each of the plurality of air cells.

5. A method of marketing comprising the steps of:
a. fabricating an air pillow having a top layer and a bottom layer;
b. heat laminating the top layer to the bottom layer to the one or more intermediate layers;
c. printing advertising on a first top sheet of the air pillow;
d. forming a one-way valve on the air pillow, wherein the one-way valve is formed by the top layer and the bottom layer; and
e. distributing the air pillow as package packing material in a flat configuration for inflating by the customer.

6. The method of marketing of claim 5, further comprising the step of: forming a plurality of micro air pockets in the intermediate sheet.

7. The method of marketing of claim 6, further comprising the step of: forming a plurality of air cells, wherein a column of logos are printed on each of the plurality of air cells.

8. The method of marketing of claim 5, further comprising the step of: forming a plurality of air cells, wherein a column of logos are printed on each of the plurality of air cells.
